(19) United States
(12) Patent Application Publication
(10) Pub. No.: US 2025/0077785 A1
(43) Pub. Date: Mar. 6, 2025

(54) SYSTEM AND METHOD TO IMPLEMENT AI/ML MODELS TO OUTPUT FEEDBACK DATA TO AUTOMATICALLY MITIGATE MICROAGGRESSION

(71) Applicant: JPMorgan Chase Bank, N.A., New York, NY (US)

(72) Inventors: Jayaprakash MOSES, Greenville, DE (US); Venkata Mohit TAMANAMPUDI, New Castle, DE (US); Priya Darshini AMARA, Glen Mills, PA (US); Sankararaman VENKATACHALAM, Middletown, DE (US); Ravi KURUGANTHY, Frisco, TX (US)

(73) Assignee: JPMorgan Chase Bank, N.A., New York, NY (US)

(21) Appl. No.: 18/798,119

(22) Filed: Aug. 8, 2024

Related U.S. Application Data
(60) Provisional application No. 63/535,436, filed on Aug. 30, 2023.

(51) Int. Cl. G06F 40/35; G06N 20/00

(52) U.S. Cl. CPC G06F 40/35; G06N 20/00

(57) ABSTRACT

Various methods and processes, apparatuses/systems, and media for generating model-based output feedback data to automatically mitigate microaggression are disclosed. A processor creates a data model based on a diverse dataset encompassing various forms of data corresponding to microaggressions; and trains the data model to identify and respond to microaggressions by implementing artificial intelligence and machine learning techniques with the diverse dataset and corresponding feedback data. The processor also receives a plurality of communication data in connection with various users via a plurality of communication channels; runs the data model to automatically generate feedback data in response to identified microaggression data tailored towards a certain user by analyzing patterns, language nuances, and contextual cues from the communication data; and transmits and displays the feedback data to a computing device via a private communication channel accessed only by the certain user so that the certain user may learn and mitigate identified microaggression.

### CROSS-REFERENCE TO RELATED APPLICATIONS

This application claims the benefit of priority from U.S. Provisional Patent Application No. 63/535,436, filed Aug. 30, 2023, which is herein incorporated by reference in its entirety.

### TECHNICAL FIELD

This disclosure generally relates to data processing, and, more particularly, to methods and apparatuses for implementing a platform, language, cloud, and database agnostic intelligent data processing module configured to implement artificial intelligence and machine learning models and techniques to output feedback data to automatically mitigate microaggression.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Most large organizations and firms have employees from various backgrounds and ethnicity working together and collaborating to create value for their firms and organizations, and interacting with clients from equally, if not more, diverse backgrounds. People may unknowingly commit microaggressions towards their colleagues or clients. Despite the best of intentions, they may end up creating a hostile environment which does not allow certain targeted groups to contribute freely because they feel they don't belong to that space, e.g., an employee asking a coworker, “Where are you from?”

Recent survey reveals that a vast majority of the people say microaggression may be a serious problem, where many have witnessed and or experienced microaggression. Moreover, a vast majority of woman employees have also reported that they have experienced gender based microaggression at work. This showcases a troubling trend in that many minorities, and vulnerable communities still feel outcasted or unsafe in the workplace.

A significant number of employees often find certain microaggressions particularly distressing, with nearly a quarter expressing their likelihood of quitting due to such incidents. These may include unprofessional conduct, hearing demeaning comments about colleagues, and having one's ideas appropriated by others.

Ongoing research consistently demonstrates that microaggression have detrimental effects on the health of minorities and people of color. These effects may encompass a wide range of issues, including elevated rates of depression, chronic stress, trauma, anxiety, and even an increased risk of developing heart disease and type 2 diabetes.

In a specific study focusing on the racial climate and microaggressions within college campuses, it was discovered that African American students faced higher levels of depression, self-doubt, frustration, and isolation, which had significant implications for their educational journey. A psychologist explains that constantly questioning whether racial factors influenced their experiences and being in a hostile environment may make individuals feel invisible, silenced, angry, and resentful.

Furthermore, the added stress resulting from workplace microaggression and encounters with discrimination may manifest in physical symptoms such as headaches, elevated blood pressure, and sleep difficulties, consequently impacting one's overall mood.

Microaggression may vary from country to country, person to person. Meaning of the sentence varies when it mixes with culture, language, country. Also, how a person speaks it and how a person hears it. Thus, giving the same microaggression training to the entire community may not be helpful because microaggression may not be same to everyone. Moreover, it may not be helpful to add all microaggression problems in one training because microaggression may be a problem that differs from person to person.

Today, a wide variety of business functions may be commonly supported by software applications and tools, i.e., business intelligence (BI) tools. For instance, software has been directed to performance analysis, report generation, project tracking, and competitive analysis, to name but a few. However, there are no tools that address microaggression.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic intelligent data processing module configured to implement artificial intelligence and machine learning models and techniques to output feedback data to mitigate microaggression, but the disclosure is not limited thereto.

In some embodiments, the present disclosure, through one or more of its various aspects, embodiments, and/or specific features or sub-components, also provides, among other features, various systems, servers, devices, methods, media, programs, and platforms for implementing a platform, language, cloud, and database agnostic intelligent data processing module configured to implement artificial intelligence and machine learning models and techniques to: output personalized feedback data onto a display or output device that helps users to better understand microaggressions reactively and proactively; transmitting alerts data to one particular person or user rather than to the whole team involved in that communication or reported elsewhere; output self-training data that helps a Large Language Model to enhance the performance; segregate microaggressions data based on geographical regions thereby ensuring cultural respect and creating an inclusive environment for every employee.

In some embodiments, a method for generating model-based output feedback data to automatically mitigate microaggression by utilizing one or more processors along with allocated memory is disclosed. The method may include: accessing a database that stores a diverse dataset encompassing various forms of data corresponding to microaggressions across an environment, wherein the environment may be provided with a plurality of communication channels for users to communicate with each other; creating a data model based on the diverse dataset; training the data model to identify and respond to microaggressions by implementing artificial intelligence and machine learning techniques with the diverse dataset and corresponding feedback data; receiving a plurality of communication data in connection with various users via said plurality of communication channels; converting the plurality of communication data into a preconfigured text format data; comparing the preconfigured text format data with the diverse dataset to identify that certain text format data in connection with a certain user corresponds to microaggression data; calling an application programming interface to run the data model to automatically generate feedback data in response to the identified microaggression data tailored towards the certain user; transmitting the feedback data to a computing device via a private communication channel accessed by only the certain user; and displaying the feedback data onto a user interface within the computing device so that the certain user may learn and mitigate identified microaggression data.

In some embodiments, the method may further include: retraining the data model with the feedback data.

In some embodiments, in training the data model, the method may further include: causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

In some embodiments, the feedback data to mitigate microaggression may include one or more of the following: recommendations data; constructive feedback data, educational resources data; and intervention strategies data, but the disclosure is not limited thereto.

In some embodiments, the diverse dataset may include microaggressions data filtered and grouped together based on geographical regions.

In some embodiments, in receiving the plurality of communication data, the method may further include: receiving voice conversation data via a plurality of video conferencing platforms; and converting the voice conversation data into an encrypted text; and decrypting the encrypted text into said preconfigured text format data.

In some embodiments, in receiving the plurality of communication data, the method may further include: receiving electronic mail data via an electronic mail platform; and converting the electronic mail data into an encrypted text; and decrypting the encrypted text into said preconfigured text format data.

In some embodiments, in receiving the plurality of communication data, the method may further include: receiving chat conversation data via an electronic chat platform; and converting the chat conversation data into an encrypted text; and decrypting the encrypted text into said preconfigured text format data.

In some embodiments, a system for generating model-based output feedback data to automatically mitigate microaggression is disclosed. The system may include: a processor; and a memory operatively connected to the processor via a communication interface, the memory storing computer readable instructions, when executed, may cause the processor to: access a database that stores a diverse dataset encompassing various forms of data corresponding to microaggressions across an environment, wherein the environment may be provided with a plurality of communication channels for users to communicate with each other; create a data model based on the diverse dataset; train the data model to identify and respond to microaggressions by implementing artificial intelligence and machine learning techniques with the diverse dataset and corresponding feedback data; receive a plurality of communication data in connection with various users via said plurality of communication channels; convert the plurality of communication data into a preconfigured text format data; compare the preconfigured text format data with the diverse dataset to identify that certain text format data in connection with a certain user corresponds to microaggression data; call an application programming interface to run the data model to automatically generate feedback data in response to the identified microaggression data tailored towards the certain user; transmit the feedback data to a computing device via a private communication channel accessed by only the certain user; and display the feedback data onto a user interface within the computing device so that the certain user may learn and mitigate identified microaggression data.

In some embodiments, the processor may be further configured to: retrain the data model with the feedback data.

In some embodiments, in training the data model, the processor may be further configured to: cause the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

In some embodiments, in receiving the plurality of communication data, the processor may be further configured to: receive voice conversation data via a plurality of video conferencing platforms; and convert the voice conversation data into an encrypted text; and decrypt the encrypted text into said preconfigured text format data.

In some embodiments, in receiving the plurality of communication data, the processor may be further configured to: receive electronic mail data via an electronic mail platform; and convert the electronic mail data into an encrypted text; and decrypt the encrypted text into said preconfigured text format data.

In some embodiments, in receiving the plurality of communication data, the processor may be further configured to: receive chat conversation data via an electronic chat platform; and convert the chat conversation data into an encrypted text; and decrypt the encrypted text into said preconfigured text format data.

In some embodiments, a non-transitory computer readable medium configured to store instructions for generating model-based output feedback data to automatically mitigate microaggression is disclosed. The instructions, when executed, may cause a processor to perform the following: accessing a database that stores a diverse dataset encompassing various forms of data corresponding to microaggressions across an environment, wherein the environment may be provided with a plurality of communication channels for users to communicate with each other; creating a data model based on the diverse dataset; training the data model to identify and respond to microaggressions by implementing artificial intelligence and machine learning techniques with the diverse dataset and corresponding feedback data; receiving a plurality of communication data in connection with various users via said plurality of communication channels; converting the plurality of communication data into a preconfigured text format data; comparing the preconfigured text format data with the diverse dataset to identify that certain text format data in connection with a certain user corresponds to microaggression data; calling an application programming interface to run the data model to automatically generate feedback data in response to the identified microaggression data tailored towards the certain user; transmitting the feedback data to a computing device via a private communication channel accessed by only the certain user; and displaying the feedback data onto a user interface within the computing device so that the certain user may learn and mitigate identified microaggression data.

In some embodiments, the instructions, when executed, may cause the processor to further perform the following: retraining the data model with the feedback data.

In some embodiments, in training the data model, the instructions, when executed, may cause the processor to further perform the following: causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

In some embodiments, in receiving the plurality of communication data, the instructions, when executed, may cause the processor to further perform the following: receiving voice conversation data via a plurality of video conferencing platforms; and converting the voice conversation data into an encrypted text; and decrypting the encrypted text into said preconfigured text format data.

In some embodiments, in receiving the plurality of communication data, the instructions, when executed, may cause the processor to further perform the following: receiving electronic mail data via an electronic mail platform; and converting the electronic mail data into an encrypted text; and decrypting the encrypted text into said preconfigured text format data.

In some embodiments, in receiving the plurality of communication data, the instructions, when executed, may cause the processor to further perform the following: receiving chat conversation data via an electronic chat platform; and converting the chat conversation data into an encrypted text; and decrypting the encrypted text into said preconfigured text format data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic intelligent data processing module configured to systemically and dynamically generate model-based output feedback data to automatically mitigate microaggression in accordance with an embodiment.

FIG. 2 illustrates a diagram of a network environment with a platform, language, database, and cloud agnostic intelligent data processing device in accordance with an embodiment.

FIG. 3 illustrates a system diagram for implementing a platform, language, database, and cloud agnostic intelligent data processing device having a platform, language, database, and cloud agnostic intelligent data processing module in accordance with an embodiment.

FIG. 4 illustrates a system diagram for implementing a platform, language, database, and cloud agnostic intelligent data processing module of FIG. 3 in accordance with an embodiment.

FIG. 5 illustrates an architecture diagram for data flow as implemented by the platform, language, database, and cloud agnostic intelligent data processing module of FIG. 4 in accordance with an embodiment.

FIG. 6 illustrates a flow chart of a process implemented by the platform, language, database, and cloud agnostic intelligent data processing module of FIG. 4 for systemically and dynamically generating model-based output feedback data to automatically mitigate microaggression in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

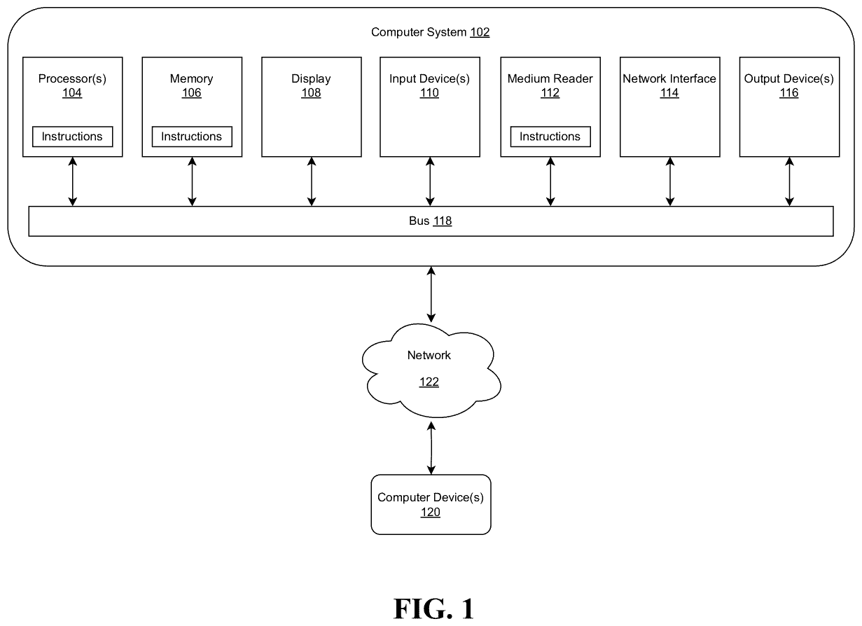

FIG. 1 is an exemplary system 100 for use in implementing a platform, language, database, and cloud agnostic intelligent data processing module configured to automatically and dynamically generate model-based output feedback data to automatically mitigate microaggression in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the intelligent data processing module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the intelligent data processing module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

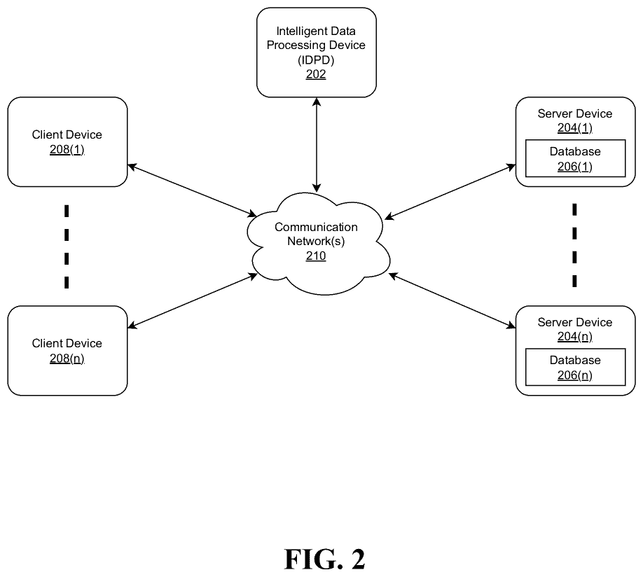

Referring to FIG. 2, a schematic of an exemplary network environment 200 for implementing a language, platform, database, and cloud agnostic intelligent data processing device (IDPD) of the instant disclosure is illustrated.

In some embodiments, the above-described problems associated with conventional tools may be overcome by implementing an IDPD 202 as illustrated in FIG. 2 that may be configured for implementing a platform, language, database, and cloud agnostic intelligent data processing module configured to implement artificial intelligence and machine learning models and techniques to output feedback data systemically and dynamically to mitigate microaggression, but the disclosure is not limited thereto.

The IDPD 202 may have one or more computer system 102s, as described with respect to FIG. 1, which in aggregate provide the necessary functions.

The IDPD 202 may store one or more applications that may include executable instructions that, when executed by the IDPD 202, cause the IDPD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the IDPD 202 itself, may be located in virtual server(s) running in a cloud-based computing environment rather than being tied to one or more specific physical network computing devices. Also, the application(s) may be running in one or more virtual machines (VMs) executing on the IDPD 202. Additionally, in one or more embodiments of this technology, virtual machine(s) running on the IDPD 202 may be managed or supervised by a hypervisor.

In the network environment 200 of FIG. 2, the IDPD 202 may be coupled to a plurality of server devices 204(1)-204(n) that hosts a plurality of databases 206(1)-206(n), and also to a plurality of client devices 208(1)-208(n) via communication network(s) 210. A communication interface of the IDPD 202, such as the network interface 114 of the computer system 102 of FIG. 1, operatively couples and communicates between the IDPD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IDPD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The IDPD 202 may be a standalone device or integrated with one or more other devices or apparatuses, such as one or more of the server devices 204(1)-204(n). In some embodiments, the IDPD 202 may be hosted by one of the server devices 204(1)-204(n), and other arrangements may also be possible. Moreover, one or more of the devices of the IDPD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the IDPD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the IDPD 202 that may efficiently provide a platform for implementing a platform, language, database, and cloud agnostic intelligent data processing module configured to implement artificial intelligence and machine learning models and techniques to output feedback data systemically and dynamically to mitigate microaggression, but the disclosure is not limited thereto.

The client devices 208(1)-208(n) may run interface applications, such as standard web browsers or standalone client applications, which may provide an interface to communicate with the IDPD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the IDPD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the IDPD 202, the server devices 204(1)-204(n), or the client devices 208(1)-208(n), in some embodiments, may be configured to operate as virtual instances on the same physical machine. In some embodiments, one or more of the IDPD 202, the server devices 204(1)-204(n), or the client devices 208(1)-208(n) may operate on the same physical device rather than as separate devices communicating through communication network(s) 210. Additionally, there may be more or fewer IDPDs 202, server devices 204(1)-204(n), or client devices 208(1)-208(n) than illustrated in FIG. 2. In some embodiments, the IDPD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

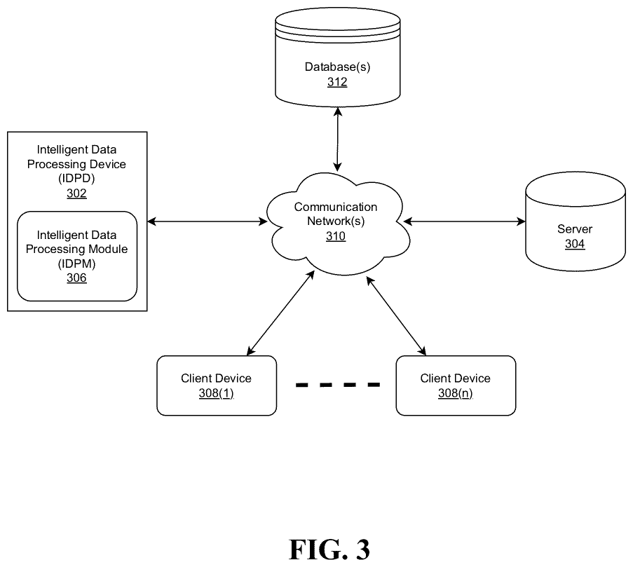

FIG. 3 illustrates a system diagram for implementing a platform, language, and cloud agnostic IDPD having a platform, language, database, and cloud agnostic intelligent data processing module (IDPM) in accordance with an embodiment.

As illustrated in FIG. 3, the system 300 may include an IDPD 302 within which an IDPM 306 may be embedded, a server 304, a database(s) 312, a plurality of client devices 308(1) . . . 308(n), and a communication network 310.

In some embodiments, the IDPD 302 including the IDPM 306 may be connected to the server 304, and the database(s) 312 via the communication network 310. The IDPD 302 may also be connected to the plurality of client devices 308(1) . . . 308(n) via the communication network 310, but the disclosure is not limited thereto.

According to exemplary embodiment, the IDPD 302 is described and shown in FIG. 3 as including the IDPM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the IDPM 306 may be configured to receive real-time feed of data from the plurality of client devices 308(1) . . . 308(n) and secondary sources via the communication network 310.

As may be described below, the IDPM 306 may be configured to: access a database that stores a diverse dataset encompassing various forms of data corresponding to microaggressions across an environment, wherein the environment may be provided with a plurality of communication channels for users to communicate with each other; create a data model based on the diverse dataset; train the data model to identify and respond to microaggressions by implementing artificial intelligence and machine learning techniques with the diverse dataset and corresponding feedback data; receive a plurality of communication data in connection with various users via said plurality of communication channels; convert the plurality of communication data into a preconfigured text format data; compare the preconfigured text format data with the diverse dataset to identify that certain text format data in connection with a certain user corresponds to microaggression data; call an application programming interface to run the data model to automatically generate feedback data in response to the identified microaggression data tailored towards the certain user; transmit the feedback data to a computing device via a private communication channel accessed by only the certain user; and display the feedback data onto a user interface within the computing device so that the certain user may learn and mitigate identified microaggression data, but the disclosure is not limited thereto.

The plurality of client devices 308(1) . . . 308(n) are illustrated as being in communication with the IDPD 302. In this regard, the plurality of client devices 308(1) . . . 308(n) may be “clients” (e.g., customers) of the IDPD 302 and are described herein as such. Nevertheless, it is to be known and understood that the plurality of client devices 308(1) . . . 308(n) need not necessarily be “clients” of the IDPD 302, or any entity described in association therewith herein. Any additional or alternative relationship may exist between either or both of the plurality of client devices 308(1) . . . 308(n) and the IDPD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the IDPD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The IDPD 302 may be the same or similar to the IDPD 202 as described with respect to FIG. 2, including any features or combination of features described with respect thereto.

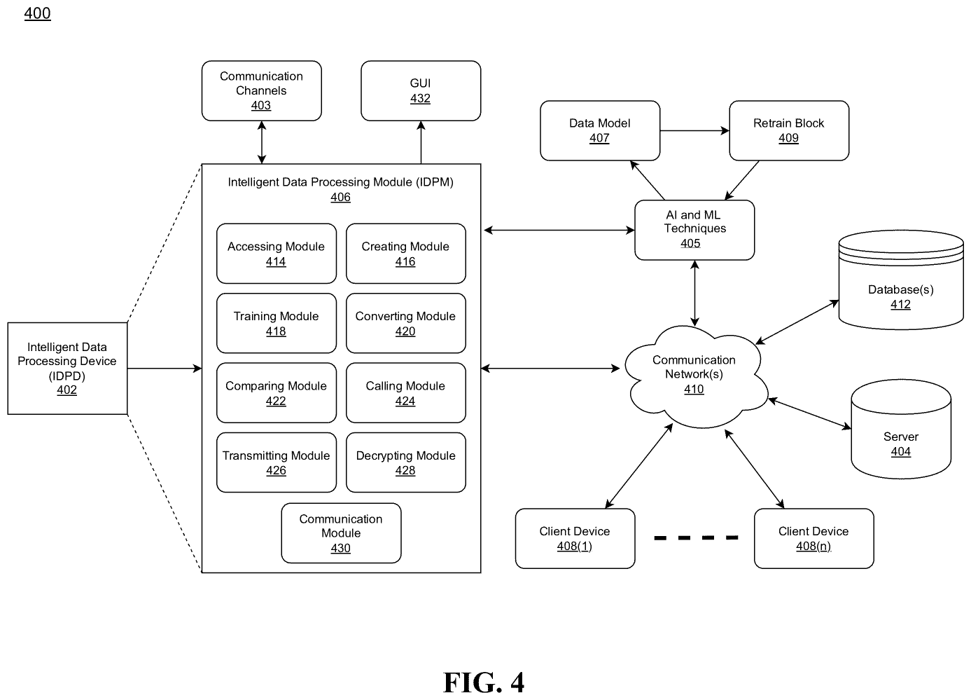

FIG. 4 illustrates a system diagram for implementing a platform, language, database, and cloud agnostic IDPM of FIG. 3 in accordance with an exemplary embodiment.

In some embodiments, the system 400 may include a platform, language, database, and cloud agnostic IDPD 402 within which a platform, language, database, and cloud agnostic IDPM 406 may be embedded, a server 404, database(s) 412, communication channels 403, a Graphical User Interface (GUI) 432, a data model 407, a retrain block 409, and a communication network 410. In some embodiments, server 404 may comprise a plurality of servers located centrally or located in different locations, but the disclosure is not limited thereto.

In some embodiments, the IDPD 402 including the IDPM 406 may be connected to the server 404, the communication channels 403, the GUI 432, the data model 407, the retrain block 409, and the database(s) 412 via the communication network 410. The IDPD 402 may also be connected to the plurality of client devices 408(1)-408(n) via the communication network 410, but the disclosure is not limited thereto. The IDPM 406, the server 404, the plurality of client devices 408(1)-408(n), the database(s) 412, the communication network 410 as illustrated in FIG. 4 may be the same or similar to the IDPM 306, the server 304, the plurality of client devices 308(1)-308(n), the database(s) 312, the communication network 310, respectively, as illustrated in FIG. 3.

In some embodiments, as illustrated in FIG. 4, the IDPM 406 may include an accessing module 414, a creating module 416, a training module 418, a converting module 420, a comparing module 422, a calling module 424, a transmitting module 426, a decrypting module 428, and a communication module 430. In some embodiments, interactions and data exchange among these modules included in the IDPM 406 provide the advantageous effects of the disclosed invention. Functionalities of each module of FIG. 4 may be described in detail below with reference to FIGS. 4-6.

In some embodiments, each of the accessing module 414, the creating module 416, the training module 418, the converting module 420, the comparing module 422, the calling module 424, the transmitting module 426, the decrypting module 428, and the communication module 430 of the IDPM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the accessing module 414, the creating module 416, the training module 418, the converting module 420, the comparing module 422, the calling module 424, the transmitting module 426, the decrypting module 428, and the communication module 430 of the IDPM 406 of FIG. 4 may be implemented by microprocessors or similar, and may be programmed using software (e.g., microcode) to perform various functions discussed herein and may optionally be driven by firmware and/or software.

Alternatively, in some embodiments, each of the accessing module 414, the creating module 416, the training module 418, the converting module 420, the comparing module 422, the calling module 424, the transmitting module 426, the decrypting module 428, and the communication module 430 of the IDPM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the IDPM 406 of FIG. 4 may also be implemented by Cloud based deployment.

In some embodiments, each of the accessing module 414, the creating module 416, the training module 418, the converting module 420, the comparing module 422, the calling module 424, the transmitting module 426, the decrypting module 428, and the communication module 430 of the IDPM 406 of FIG. 4 may be called via corresponding API, but the disclosure is not limited thereto. In some embodiments, calls may also be made using Event based message interfaces in addition to APIs.

In some embodiments, the process implemented by the IDPM 406 may be executed via the communication module 430, the communication channels 403, and the communication network 410, which may comprise plural networks as described above. In some embodiments, in an exemplary embodiment, the various components of the IDPM 406 may communicate with the server 404, and the database(s) 412 via the communication module 430 and the communication network 410 and the results may be displayed onto the GUI 432. Of course, these embodiments are merely exemplary and are not limiting or exhaustive. The database(s) 412 may include the databases included within the private cloud and/or public cloud and the server 404 may include one or more servers within the private cloud and the public cloud.

In some embodiments, the accessing module 414 may be configured to access the database 412 that stores a diverse dataset encompassing various forms of data corresponding to microaggressions across an environment. In some embodiments, the environment may be provided with a plurality of communication channels 403 for users to communicate with each other via a user interface embedded within the client device 408(1)-408(n).

In some embodiments, the creating module 416 may be configured to create a data model 407 based on the diverse dataset. The training module 418 may be configured to train the data model 407 to identify and respond to microaggressions by implementing artificial intelligence (AI) and machine learning (ML) techniques 405 with the diverse dataset and corresponding feedback data.

In some embodiments, the IDPM 406 receives a plurality of communication data in connection with various users via the plurality of communication channels 403. The converting module 420 may be configured to convert the plurality of communication data into a preconfigured text format data. The comparing module 422 may be configured to compare the preconfigured text format data with the diverse dataset to identify that certain text format data in connection with a certain user corresponds to microaggression data.

In some embodiments, the calling module 424 may be configured to call an application programming interface to run the data model 407 to automatically generate feedback data in response to the identified microaggression data tailored towards the certain user. The transmitting module 426 may be configured to transmit the feedback data to a computing device (i.e., client device 408(1)-408(n)) via a private communication channel accessed by only the certain user utilizing the communication module 430. The IDPM 406 may cause the GUI 432 to display the feedback data onto a user interface within the computing device (i.e., client device 408(1)-408(n)) so that the certain user may learn and mitigate identified microaggression data.

In some embodiments, the training module 418 may be further configured to retrain the data model 407 with the feedback data by invoking the retrain block 409.

In some embodiments, in training the data model 407, the training module 418 may be further configured to cause the data model 407 to continuously learn to recognize and categorize micro aggressive behaviors accurately by analyzing patterns data, language nuances data, and contextual cues data from the preconfigured text format data. The comparing module 422 may be configured to compare the patterns data, the language nuances data, and the contextual cues data with the diverse dataset encompassing the various forms of data corresponding to microaggressions.

In some embodiments, the feedback data to mitigate microaggression may include one or more of the following: recommendations data; constructive feedback data, educational resources data; and intervention strategies data, but the disclosure is not limited thereto.

In some embodiments, the diverse dataset may include microaggressions data filtered and grouped together based on geographical regions, but the disclosure is not limited thereto.

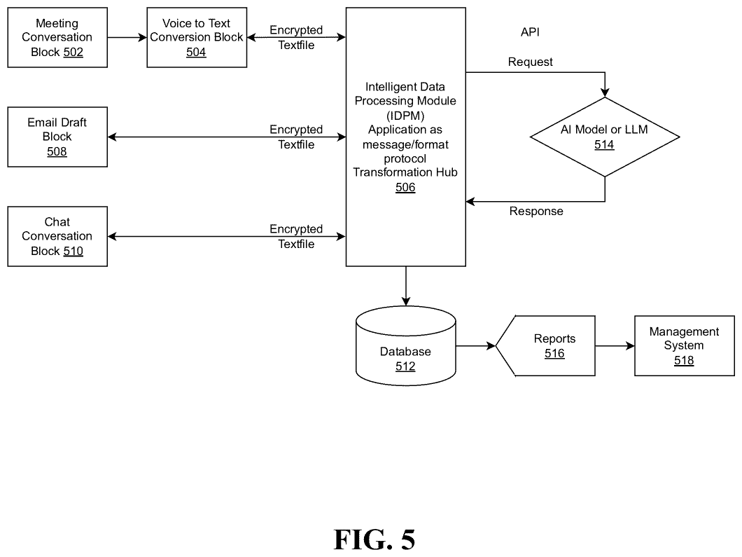

In some embodiments, FIG. 5 illustrates an exemplary architecture diagram 500 for data flow as implemented by the platform, language, database, and cloud agnostic IDPM 406 of FIG. 4 in accordance with an exemplary embodiment. As illustrated in FIG. 5, the exemplary architecture diagram 500 for data flow may include a meeting conversation block 502, a voice or text conversion block 504, an IDPM 506 which may be an application as message/format protocol transformation hub, an email block 508, a chat conversation block 510, a database 512, reports 516 and a management system 518.

Referring to FIGS. 4 and 5, in some embodiments, in receiving the plurality of communication data, the IDPM 406, 506 may be configured to receive voice conversation data via a plurality of video conferencing platforms, but the disclosure is not limited thereto, via corresponding communication channels 403. In some embodiments, the plurality of communication channels 403 may implement corresponding communication channel connectors, i.e., connectors for each of the plurality of video conferencing platforms, but the disclosure is not limited thereto.

The voice to text conversion block 504 may invoke the converting module 420 to convert the voice conversation data into an encrypted text by utilizing an encrypting tool. The decrypting module 428 may be configured to decrypt the encrypted text corresponding to meeting conversation data into the preconfigured text format data.

In some embodiments, voice conversation from the meeting conversation block 502 may be captured using plugin installed within the corresponding voice/video conversation application. Recorded audio may then be converted to encrypted text. The IDPM 506 application then sends the data to AI/ML model 514 for analysis utilizing API request and initiates feedback if any microaggressions are found in the communication. The AI/ML model 514 may send the feedback to the plugin installed within the corresponding voice/video conversation application. The IDPM 506 may generate reports 516 based on the received feedback and store the reports 516 onto the database 512 for consumption by the management system 518. Users may be notified privately and could read more about the incident along with any suggested internal training or resources.

In some embodiments, in receiving the plurality of communication data, the IDPM 406, 506 may be further configured to receive electronic mail data via an electronic mail platform within the email draft block 508. The converting module 420 may be invoked to convert the electronic mail data into an encrypted text by utilizing an encrypting tool. The decrypting module 428 may be configured to decrypt the encrypted text corresponding to electronic mail data into the preconfigured text format data.

In some embodiments, electronic mail data from the email draft block 508 may be captured using plugin installed within the email application. Captured data may then be converted to encrypted text. The IDPM 506 application then sends the data to AI/ML model 514 for analysis utilizing API request and initiates feedback if any microaggressions are found in the email communication. The AI/ML model 514 may send the feedback to the plugin installed within the email application. The IDPM 506 may generate reports 516 based on the received feedback and store the reports 516 onto the database 512 for consumption by the management system 518. Users may be notified privately and could read more about the incident along with any suggested internal training or resources.

In some embodiments, in receiving the plurality of communication data, the IDPM 406, 506 may be further configured to receive chat conversation data via an electronic chat platform embedded within the chat conversation block 510. The converting module 420 may be invoked to convert the chat conversation data into an encrypted text by utilizing an encrypting tool. The decrypting module 428 may be configured to decrypt the encrypted text corresponding to chat conversation data into the preconfigured text format data.

In some embodiments, according to an exemplary embodiments, chat conversation data from the chat conversation block 510 may be captured using plugin installed within the chat application. Captured chat conversation data may then be converted to encrypted text. The IDPM 506 application then sends the data to AI/ML model 514 for analysis utilizing API request and initiates feedback if any microaggressions are found in the chat conversation. The AI/ML model 514 may send the feedback to the plugin installed within the chat application. The IDPM 506 may generate reports 516 based on the received feedback and store the reports 516 onto the database 512 for consumption by the management system 518. Users may be notified privately and could read more about the incident along with any suggested internal training or resources.

In some embodiments, the GUI 432 as illustrated in FIG. 4, may include a visualization layer showing microaggression metrics at workplace. All metrics displayed in the visualization layers may be aggregated and would not refer to individual employees. In some embodiments, personalized feedback helps users/employees to better understand microaggressions reactively and proactively. Making sure alerts go to one person rather than to the whole team involved in that communication or reported elsewhere. Self-training helps the Large Language Model enhance the performance. Segregation of microaggressions based on geographical regions ensures cultural respect.

In some embodiments, the AI/ML model 514 design may include a process of creating algorithms and architectures that may learn from the data and make intelligent decisions.

Referring back to FIGS. 4 and 5, in some embodiments, the IDPM 406, 506 may be configured to define a problem statement that the AI/ML model 514 may need to solve and determine the goals and objectives. The IDPM 406, 506 may be configured to access relevant data from the meeting conversation block 502, email draft block 508, chat conversation block 510, by utilizing the accessing module 414, that represents the problem domain and may process the relevant data to ensure it may be clean and normalized and properly formatted for training the AI/ML model 514.

In some embodiments, the IDPM 406, 506 may be configured to apply a semantic analysis process for finding meaning in a statement, i.e., the literal meaning of words, phrases, and sentences.

In some embodiments, the IDPM 406, 506 may be utilized by a user to apply the semantic analysis process to place words in a manner to form complete sentences; extract the text's exact meaning or dictionary definition; map the task domain's syntactic structures and objects by examining the exact meaning of the text, but the disclosure is not limited thereto.

In some embodiments, the IDPM 406, 506 may be configured to apply a discourse integration process in which the meaning of any sentence may be determined by the meaning of the sentence immediately preceding it. In addition, the IDPM 406, 506 may be configured to apply the discourse integration process to establish the meaning of the sentence that follows.

In some embodiments, the IDPM 406, 506 may be configured to apply a pragmatic analysis process which may utilize a set of rules that describe cooperative dialogues to help a user find an intended result, i.e., word repetition, who said what to whom, etc., but the disclosure is not limited thereto.

In some embodiments, depending on the problem type, available data, and desired outcome, the IDPM 406, 506 may be configured to select an appropriate AI or Large Language Model (LLM). According to an embodiment, this may include selecting, by the IDPM 406, 506, open source AI model or anthropic or huggingface, cohere or any other models suitable for utilizing in the natural language processing algorithms disclosed herein for better accuracy on prediction tasks, but the disclosure is not limited thereto. In LLM, this may involve determining, by the IDPM 406, 506, the temperature, max length, context window size, prompt template, etc. In some embodiments, assigning, by the IDPM 406, 506, the temperature to a configurable value may reduce hallucination, and zero shot promoting, by the IDPM 406, 506, may reduce context window size. In some embodiments, the temperature may be between 0 and 1, more specifically, the temperature may be between 0.7 and 0.3. In an embodiment, the temperature may be 0.5.

In some embodiments, the AI/ML model 514 may further be fine-tuned to elevate results. Such fine tuning may include fine tuning the AI/ML model 514 using the diversity, equity and inclusion (DEI) phrases, modifying hyperparameters like epochs, learning rate multiplier, batch size, etc., to improve performance of the AI/ML model 514.

Referring back to FIGS. 4 and 5, in some embodiments, the training module 418 may be configured to assess the performance of the trained AI/ML model 514 using appropriate evaluation metrics, such as step, train_loss, train_accuracy, valid_losss, valid_mean_token accuracy, etc., but the disclosure is not limited thereto. In some embodiments, the training module 418 may be further configured to continuously train the AI/ML model 514 with the data received from the meeting conversation block 502, the email draft block 508, the chat conversation block 510, and the latest DEI phrases to improve performance of the AI/ML model 514.

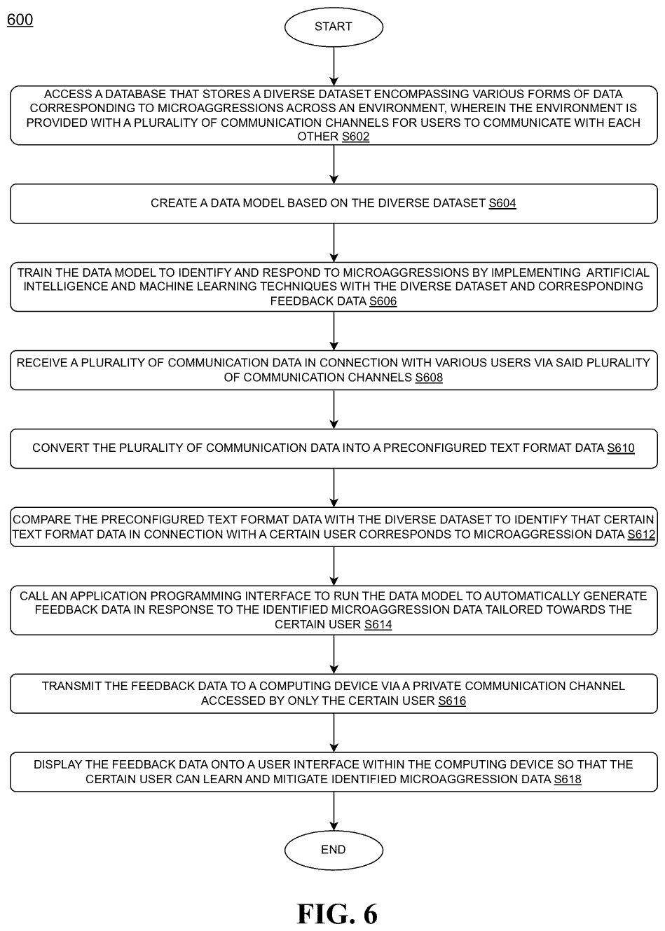

FIG. 6 illustrates an exemplary flow chart of a process 600 implemented by the platform, language, database, and cloud agnostic IDPM 406 of FIG. 4 for systemically and dynamically generating model-based output feedback data to automatically mitigate microaggression in accordance with an exemplary embodiment. It may be appreciated that the illustrated process 600 and associated steps may be performed in a different order, with illustrated steps omitted, with additional steps added, or with a combination of reordered, combined, omitted, or additional steps.

As illustrated in FIG. 6, at step S602, the process 600 may include accessing a database that stores a diverse dataset encompassing various forms of data corresponding to microaggressions across an environment. The environment may be provided with a plurality of communication channels for users to communicate with each other.

At step S604, the process 600 may include creating a data model based on the diverse dataset.

At step S606, the process 600 may include training the data model to identify and respond to microaggressions by implementing artificial intelligence and machine learning techniques with the diverse dataset and corresponding feedback data. A node in the code graph represents a component in the code base and an edge in the code graph may be a directed or ordered relationship between two components.

At step S608, the process 600 may include receiving a plurality of communication data in connection with various users via said plurality of communication channels.

At step S610, the process 600 may include converting the plurality of communication data into a preconfigured text format data.

At step S612, the process 600 may include comparing the preconfigured text format data with the diverse dataset to identify that certain text format data in connection with a certain user corresponds to microaggression data.

At step S614, the process 600 may include calling an application programming interface to run the data model to automatically generate feedback data in response to the identified microaggression data tailored towards the certain user.

At step S616, the process 600 may include transmitting the feedback data to a computing device via a private communication channel accessed by only the certain user.

At step S618, the process 600 may include displaying the feedback data onto a user interface within the computing device so that the certain user may learn and mitigate identified microaggression data.

In some embodiments, the process 600 may further include: retraining the data model with the feedback data.

In some embodiments, in training the data model, the process 600 may further include: causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

In some embodiments, in the process 600, the feedback data to mitigate microaggression may include one or more of the following: recommendations data; constructive feedback data, educational resources data; and intervention strategies data, but the disclosure is not limited thereto.

In some embodiments, in the process 600, the diverse dataset may include microaggressions data filtered and grouped together based on geographical regions, but the disclosure is not limited thereto.

In some embodiments, in receiving the plurality of communication data, the process 600 may further include: receiving voice conversation data via a plurality of video conferencing platforms; and converting the voice conversation data into an encrypted text; and decrypting the encrypted text into said preconfigured text format data.

In some embodiments, in receiving the plurality of communication data, the process 600 may further include: receiving electronic mail data via an electronic mail platform; and converting the electronic mail data into an encrypted text; and decrypting the encrypted text into said preconfigured text format data.

In some embodiments, in receiving the plurality of communication data, the process 600 may further include: receiving chat conversation data via an electronic chat platform; and converting the chat conversation data into an encrypted text; and decrypting the encrypted text into said preconfigured text format data.

In some embodiments, the IDPD 402 may include a memory (e.g., a memory 106 as illustrated in FIG. 1) which may be a non-transitory computer readable medium that may be configured to store instructions for implementing a platform, language, database, and cloud agnostic IDPM 406 for systemically and dynamically generating model-based output feedback data to automatically mitigate microaggression as disclosed herein. The IDPD 402 may also include a medium reader (e.g., a medium reader 112 as illustrated in FIG. 1) which may be configured to read any one or more sets of instructions, e.g., software, from any of the memories described herein. The instructions, when executed by a processor embedded within the IDPM 406 or within the IDPD 402, may be used to perform one or more of the process 600s and processes as described herein. In a particular embodiment, the instructions may reside completely, or at least partially, within the memory 106, the medium reader 112, and/or the processor 104 (see FIG. 1) during execution by the IDPD 402.

In some embodiments, the instructions, when executed, may cause a processor embedded within the IDPM 406 or the IDPD 402 to perform the following: accessing a database that stores a diverse dataset encompassing various forms of data corresponding to microaggressions across an environment, wherein the environment may be provided with a plurality of communication channels for users to communicate with each other; creating a data model based on the diverse dataset; training the data model to identify and respond to microaggressions by implementing artificial intelligence and machine learning techniques with the diverse dataset and corresponding feedback data; receiving a plurality of communication data in connection with various users via said plurality of communication channels; converting the plurality of communication data into a preconfigured text format data; comparing the preconfigured text format data with the diverse dataset to identify that certain text format data in connection with a certain user corresponds to microaggression data; calling an application programming interface to run the data model to automatically generate feedback data in response to the identified microaggression data tailored towards the certain user; transmitting the feedback data to a computing device via a private communication channel accessed by only the certain user; and displaying the feedback data onto a user interface within the computing device so that the certain user may learn and mitigate identified microaggression data. In some embodiments, the processor may be the same or similar to the processor 104 as illustrated in FIG. 1 or the processor embedded within the IDPD 202, IDPD 302, IDPD 402, and IDPM 406 which may be the same or similar to the processor 104.

In some embodiments, the instructions, when executed, may cause the processor 104 to further perform the following: retraining the data model with the feedback data.

In some embodiments, in training the data model, the instructions, when executed, may cause the processor 104 to further perform the following: causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

In some embodiments, in receiving the plurality of communication data, the instructions, when executed, may cause the processor 104 to further perform the following: receiving voice conversation data via a plurality of video conferencing platforms; and converting the voice conversation data into an encrypted text; and decrypting the encrypted text into said preconfigured text format data.

In some embodiments, in receiving the plurality of communication data, the instructions, when executed, may cause the processor 104 to further perform the following: receiving electronic mail data via an electronic mail platform; and converting the electronic mail data into an encrypted text; and decrypting the encrypted text into said preconfigured text format data.

In some embodiments, in receiving the plurality of communication data, the instructions, when executed, may cause the processor 104 to further perform the following: receiving chat conversation data via an electronic chat platform; and converting the chat conversation data into an encrypted text; and decrypting the encrypted text into said preconfigured text format data.

In some embodiments as disclosed above in FIGS. 1-6, technical improvements effected by the instant disclosure may include a platform for implementing a platform, language, database, and cloud agnostic intelligent data processing module configured to implement artificial intelligence and machine learning models and techniques to output feedback data systemically and dynamically to mitigate microaggression, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, process 600s, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or process 600s described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for generating model-based output feedback data to automatically mitigate microaggression by utilizing one or more processors along with allocated memory, the method comprising:
accessing a database that stores a diverse dataset encompassing various forms of data corresponding to microaggressions across an environment, wherein the environment is provided with a plurality of communication channels for users to communicate with each other;
creating a data model based on the diverse dataset;
training the data model to identify and respond to microaggressions by implementing artificial intelligence and machine learning techniques with the diverse dataset and corresponding feedback data;
receiving a plurality of communication data in connection with various users via said plurality of communication channels;
converting the plurality of communication data into a preconfigured text format data;
comparing the preconfigured text format data with the diverse dataset to identify that certain text format data in connection with a certain user corresponds to microaggression data;
calling an application programming interface to run the data model to automatically generate feedback data in response to the identified microaggression data tailored towards the certain user;
transmitting the feedback data to a computing device via a private communication channel accessed by only the certain user; and
displaying the feedback data onto a user interface within the computing device so that the certain user may learn and mitigate identified microaggression data.

2. The method according to claim 1, further comprising:
retraining the data model with the feedback data.

3. The method according to claim 1, in training the data model, the method further comprising:
causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

4. The method according to claim 1, wherein the feedback data to mitigate microaggression includes one or more of the following: recommendations data; constructive feedback data, educational resources data; and intervention strategies data.

5. The method according to claim 1, wherein the diverse dataset includes microaggressions data filtered and grouped together based on geographical regions.

6. The method according to claim 1, in receiving the plurality of communication data, the method further comprising:
receiving voice conversation data via a plurality of video conferencing platforms; and
converting the voice conversation data into an encrypted text; and
decrypting the encrypted text into said preconfigured text format data.

7. The method according to claim 1, in receiving the plurality of communication data, the method further comprising:
receiving electronic mail data via an electronic mail platform; and
converting the electronic mail data into an encrypted text; and
decrypting the encrypted text into said preconfigured text format data.

8. The method according to claim 1, in receiving the plurality of communication data, the method further comprising:
receiving chat conversation data via an electronic chat platform; and
converting the chat conversation data into an encrypted text; and
decrypting the encrypted text into said preconfigured text format data.

9. A system for generating model-based output feedback data to automatically mitigate microaggression, the system comprising:
a processor; and
a memory operatively connected to the processor via a communication interface, the memory storing computer readable instructions, when executed, causes the processor to:
access a database that stores a diverse dataset encompassing various forms of data corresponding to microaggressions across an environment, wherein the environment is provided with a plurality of communication channels for users to communicate with each other;
create a data model based on the diverse dataset;
train the data model to identify and respond to microaggressions by implementing artificial intelligence and machine learning techniques with the diverse dataset and corresponding feedback data;
receive a plurality of communication data in connection with various users via said plurality of communication channels;
convert the plurality of communication data into a preconfigured text format data;
compare the preconfigured text format data with the diverse dataset to identify that certain text format data in connection with a certain user corresponds to microaggression data;
call an application programming interface to run the data model to automatically generate feedback data in response to the identified microaggression data tailored towards the certain user;
transmit the feedback data to a computing device via a private communication channel accessed by only the certain user; and
display the feedback data onto a user interface within the computing device so that the certain user may learn and mitigate identified microaggression data.

10. The system according to claim 9, wherein the processor is further configured to:
retrain the data model with the feedback data.

11. The system according to claim 9, in training the data model, the processor is further configured to:
cause the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

12. The system according to claim 9, wherein the feedback data to mitigate microaggression includes one or more of the following: recommendations data; constructive feedback data, educational resources data; and intervention strategies data.

13. The system according to claim 9, wherein the diverse dataset includes microaggressions data filtered and grouped together based on geographical regions.

14. The system according to claim 9, in receiving the plurality of communication data, the processor is further configured to:
receive voice conversation data via a plurality of video conferencing platforms; and
convert the voice conversation data into an encrypted text; and
decrypt the encrypted text into said preconfigured text format data.

15. The system according to claim 9, in receiving the plurality of communication data, the processor is further configured to:
receive electronic mail data via an electronic mail platform; and
convert the electronic mail data into an encrypted text; and
decrypt the encrypted text into said preconfigured text format data.

16. The system according to claim 9, in receiving the plurality of communication data, the processor is further configured to:
receive chat conversation data via an electronic chat platform; and
convert the chat conversation data into an encrypted text; and
decrypt the encrypted text into said preconfigured text format data.

17. A non-transitory computer readable medium configured to store instructions for generating model-based output feedback data to automatically mitigate microaggression, the instructions, when executed, cause a processor to perform the following:
accessing a database that stores a diverse dataset encompassing various forms of data corresponding to microaggressions across an environment, wherein the environment is provided with a plurality of communication channels for users to communicate with each other;
creating a data model based on the diverse dataset;
training the data model to identify and respond to microaggressions by implementing artificial intelligence and machine learning techniques with the diverse dataset and corresponding feedback data;
receiving a plurality of communication data in connection with various users via said plurality of communication channels;
converting the plurality of communication data into a preconfigured text format data;
comparing the preconfigured text format data with the diverse dataset to identify that certain text format data in connection with a certain user corresponds to microaggression data;
calling an application programming interface to run the data model to automatically generate feedback data in response to the identified microaggression data tailored towards the certain user;
transmitting the feedback data to a computing device via a private communication channel accessed by only the certain user; and
displaying the feedback data onto a user interface within the computing device so that the certain user may learn and mitigate identified microaggression data.

18. The non-transitory computer readable medium according to claim 17, wherein the instructions, when executed cause the processor to further perform the following:
retraining the data model with the feedback data.

19. The non-transitory computer readable medium according to claim 17, in training the data model, the instructions, when executed cause the processor to further perform the following:
causing the data model to continuously learn to recognize and categorize micro aggressive behaviors accurately by analyzing patterns data, language nuances data, and contextual cues data from said preconfigured text format data and comparing the patterns data, the language nuances data, and the contextual cues data with the diverse dataset encompassing the various forms of data corresponding to microaggressions.

20. The non-transitory computer readable medium according to claim 17, wherein the feedback data to mitigate microaggression includes one or more of the following: recommendations data; constructive feedback data, educational resources data; and intervention strategies data, and wherein the diverse dataset includes microaggressions data filtered and grouped together based on geographical regions.
